(19) United States
(12) Patent Application Publication
(10) Pub. No.: US 2023/0150856 A1
(43) Pub. Date: May 18, 2023

(54) FURNACE FOR THE MELTING OF VITRIFIABLE MATERIAL

(71) Applicant: COMBUSTION CONSULTING ITALY S.R.L., Verona (IT)

(72) Inventor: Oleg BOULANOV, Nogent-sur-Oise (FR)

(21) Appl. No.: 17/995,361

(22) PCT Filed: Mar. 4, 2021
(86) PCT No.: PCT/EP2021/055431

§ 371 Date: Oct. 3, 2022

(30) Foreign Application Priority Data
Apr. 3, 2020 (IT) 102020000007099

(51) Int. Cl. C03B 5/44; C03B 5/43

(52) U.S. Cl. CPC C03B 5/44; C03B 5/43

(57) ABSTRACT

A furnace for melting vitrifiable material has a composable wall structure, formed by modules, each comprising two flat metal panels separated by a gap for the circulation of cooling water.

### FIELD

The present disclosure relates to a furnace for melting vitrifiable material, or waste containing it.

### INTRODUCTION

Furnaces intended to melt vitrifiable material are known on the market.

Such furnaces must reach temperatures ranging from 1200° C. to 1600° C. in order to correctly and completely melt the vitrifiable material, the composition of which may vary from time to time.

In order to find industrial application on a large scale, furnaces must obviously have a simple and economical but solid structure, having to withstand the very high temperatures reached.

The various solutions on the market, albeit functional, feature however a poor versatility of use so they often fail to adapt flexibly to specific applications.

US2011/0236846 discloses a furnace that, due to its configuration, can feature some drawbacks in industrial scale use, among which the risk of being obstructed after a certain period of activity. Indeed, due to the intense bubbling of the melt inside the furnace, droplets or large blocks of the melt can be taken up together with hot gases. Upon entry in the colder part of the outlet ascending channel, these drops or blocks quickly freeze and therefore completely block the outlet channel. Thus, a pressure pulsating field of hot gases is created in the furnace above the melt. These pressure pulsations above the melt creates very large pulsations of the melt jet at the furnace outlet. This in turn can lead to a large degradation of product quality at the exit from the fiberizing unit. Furthermore, due to the profile of the outlet channel, large lumps of melt can be shot far into the flue. The chimney usually has a weaker thermal protection than the furnace itself. Thus, there can be also a risk of complete closure or wear of the flue material.

### SUMMARY

The task of the present disclosure is therefore to realize a furnace for melting vitrifiable material which allows to eliminate the technical drawbacks of the prior art.

Within the task of this technical task, an object of the present disclosure is to realize a

furnace for melting vitrifiable material which is constructively robust, simple and economical, easy to assemble, disassemble and maintain.

Another object of the present disclosure is to realize a furnace for melting vitrifiable material which can be easily adapted to specific applications.

The technical task, as well as these and other objects, according to the present disclosure are achieved by realizing a furnace for melting vitrifiable material, characterized in that it has a composable wall structure, formed by modules, each comprising a pair of flat metal panels separated by a gap for the circulation of cooling water.

In one embodiment, said gap has baffles for channelling the water.

In one embodiment, said channelling baffles are formed by flat metal strips fixed orthogonally to said two panels.

In one embodiment, said panels of each module are connected by bolts that traverse said gap.

In one embodiment, said modules have perimetral coupling flanges.

In one embodiment, said wall structure comprises at least one bottom module, bounding modules for bounding a melting tank in cooperation with said bottom module, at least one top module provided with a discharge opening for discharging the gases produced in the melting tank, and bounding modules for bounding an upward conveying labyrinth channel for conveying said gases upwards from the port of said melting tank to said discharge opening.

The furnace is provided with burners which can operate from below if they are applied through the bottom module, from the side if they are applied through the bounding modules for bounding the melting tank, or even from above if they are applied through the bounding modules for bounding the labyrinth channel.

In one embodiment, said bounding modules for bounding said labyrinth channel comprise at least one module tilting upwards overlapping the port of the melting tank.

In one embodiment, said tilted module protrudes upward inside said wall structure.

In one embodiment, the side of said tilted module opposite said melting tank bounds an accumulating zone for accumulating material conveyed by said gases.

In one embodiment, said labyrinth path has passage sections of a different area to accelerate and slow the ascending gas flow.

In one embodiment, the solidified material that is deposited in said accumulating zone forms a sliding surface of another material sliding to the melting bath.

The module tilted upward advantageously is arranged as a barrier that, by intercepting the ascending gas flow, promotes separating, from the ascending gas flow, particles of solidified material that slide along said tilted module to return to the melting bath.

The present disclosure also discloses a furnace for melting vitrifiable material, characterized in that it has a composable wall structure comprising at least one bottom module, bounding modules for bounding a melting tank in cooperation with said bottom module , at least one top module provided with a discharge opening for discharging the gases produced in the melting tank , and bounding modules for bounding an upward conveying labyrinth channel for conveying said gases upwards from the port of said melting tank to said discharge opening, said bounding modules for bounding said labyrinth channel comprise at least one module tilting upwards overlapping the port of the melting tank, said tilted module protrudes upward inside said wall structure, wherein said bottom module is rectangular or square shaped, has dimension of each perimeter side in a range between 2 m and 4 m, has parallel rows of longitudinal apertures for housing burners parallel to two opposite perimeter sides of said bottom module, said longitudinal apertures having a pitch in range between 0.3 m and 0.6 m and a distance from said perimeter sides in a range between 0.1 m and 0.7 m.

The furnace thus conceived has numerous advantages.

The furnace, due to its composable modular structure, is extremely easy to assemble and disassemble, clean and maintain.

The shape, the dimensions and the proportions thereof between the various parts can be flexibly adapted to specific applications.

The module, being formed by flat metal panels and straight metal strips, is very easy to assemble.

The components of the module, essentially metal panels, metal strips and hardware, are easy to produce without complex mechanical processes and/or are easily commercially available.

From the functional point of view, water cooling preserves the structural integrity by considerably increasing the average life of the furnace, also thanks to the special configuration and arrangement of the water channelling which allows a uniform cooling of the module.

The chimney, that is the upper part of the furnace with the gas discharge opening, thanks to the upward conveying labyrinth channel for conveying said gases upwards, is completely protected and free from the risk of obstruction from splashes of material coming from the melting tank.

The upward conveying labyrinth channel subjects the gases produced in the melting tank to a turbulent motion which promotes the precipitation of the material conveyed by the gases themselves. This material therefore does not obstruct the chimney and can be recovered in the accumulating zone and then be re-introduced into the melting tank.

The particular embodiment with oblique modules of the labyrinth channel reduces the presence of drops of solidified molten material in the fumes. The labyrinth path ensures that the fumes in contact with the upper oblique modules cause the solidified drops to attach to the walls of the oblique modules and the consequent dripping along the walls bringing the material back into the melting bath. In addition, vortices or air circulation systems traversing a narrow section of the labyrinth channel increase and then decrease the speed drastically in the subsequent passage section with greater area and consequently cause drops of solidified material to deposit, creating an accumulation of material that can be either removed by hand, or allowed accumulating in such a way as to create an internal sliding surface (made of accumulated material) of the further particles, toward the melting bath.

Moreover, it must be pointed out that the labyrinth channel on the one hand shields the chimney from the radiations emitted by the material present in the melting tank, protecting it from excessive heating, on the other hand it reflects these radiations toward the inside of the melting tank.

The reflected radiation cooperates for the melting of the material present in the melting tank thus increasing the thermal efficiency of the furnace.

The flue gas can also be recovered to further improve the thermal efficiency of the furnace.

### BRIEF DESCRIPTION OF THE DRAWINGS

Further characteristics and advantages of the present disclosure will become better apparent from the description of a preferred but not exclusive embodiment of the furnace for melting vitrifiable material according to the present disclosure, illustrated only by way of non-limiting example in the accompanying drawings, wherein:

FIG. 1 shows a schematic exploded view of a first embodiment of the furnace; FIG. 2 shows a top view of the furnace of FIG. 1;

FIG. 3 shows a vertical section of the furnace of FIG. 1;

FIG. 4 shows a schematic exploded view of a second embodiment of the furnace;

FIG. 5 shows a top view of the furnace of FIG. 4;

FIG. 6 shows a vertical section of the furnace of FIG. 4;

FIG. 7 shows a side elevation view of a possible module of the wall structure, in which a panel is shown in transparency and the bolts are omitted for the purpose of appreciating the internal channelling of the module;

FIG. 8 shows a section of the module taken along the line G-G of FIG. 7;

FIG. 9 shows a section of the module taken along the line D-D of FIG. 7;

FIG. 10 shows a section of the module taken along the line A-A of FIG. 7.

Equivalent parts in the various embodiments will be indicated by the same reference number.

### DETAILED DESCRIPTION

With reference to the above figures, a furnace for melting vitrifiable material, generally designated by the reference numeral 1, is shown.

The furnace 1 has a composable wall structure, formed by modules 2i, 2ii, 2iii, 2iv, 2v, 2vi, 2viii, 2ix, 2x, 2xi, 2xii, each comprising panels 3a, 3b separated by a by a gap 4 for the circulation of cooling water.

The panels 3a, 3b are preferably flat.

The panels 3a, 3b are also preferably metallic, in particular steel.

Each module comprises more precisely two parallel panels 3a, 3b separated by the gap 4.

The gap 4 between the two panels 3a, 3b has baffles 5a, 5b for channelling the water.

Each module has at least one water inlet collector 15 and at least one water outlet collector 16 and is configured for a hydraulic connection in series or in parallel with the adjacent modules.

The baffles 5a, 5b are formed by flat metal strips, in particular steel.

The baffles 5a, 5b are fixed orthogonally to the panels 3a, 3b.

The panels 3a, 3b are connected by bolts 7 that traverse the gap 4.

The bolts 7 give resistance to the swelling of the panels 3a, 3b which are subjected to the pressure of the water circulating in the module which can reach 10 bar.

In particular, the baffles 5a, 5b are welded to the panels 3a, 3b positioned on the side of the melting tank and are simply clamped by the bolts 7 to the panels 3a, 3b positioned on the side opposite the melting tank.

The baffles 5a, 5b comprise inner baffles 5a of the module 2 and perimeter baffles 5b of the module that close on the perimeter the gap 4.

The inner baffles 5a are ordered in an array of parallel baffles separated by a passage space 21 from the perimeter baffles 5b.

The inner baffles 5a separate rectilinear portions 22 of a water channel connected by portions 23 curved at 180° of the water channel which include the passage space 21 and are bounded by the perimeter baffles 5b.

The water channelling in the module is therefore formed by a water channel which extends as a coil.

In the modules of the wall structure arranged vertically or tilted, the water channelling has the rectilinear portions 22 of the water channels oriented horizontally.

In this way, the creation of pockets of water stagnation is avoided which, if present, could alter the correct heat exchange with consequent risk of compromising the wall structure.

The modules of the wall structure can have different shapes and sizes and have perimeter flanges for reciprocal coupling.

The modules can be reciprocally bolted or welded or bolted and welded.

The panels 3a, 3b of the module may have the same shape but different dimensions.

In this case, the perimeter baffles 5b can be applied along the perimeter edge of the smaller panel 3b.

Some perimeter baffles 5b may have a greater height than the gap 4 and may project orthogonally from of one of the panels 3a, 3b.

The projecting flap 8a of the perimeter baffles 5b can thus act as a perimeter flange for the coupling to an adjacent module.

Some perimeter baffles 5b may extend in a retracted position with respect to at least some sides of the perimeter edge of the larger panel 3a.

The flap 8b of the larger panel 3a present between its perimeter edge and a perimeter baffle 5b can thus act as a perimeter flange for the coupling to an adjacent module.

The flanges 8a, 8b of the adjacent modules are coupled by means of fixing bolts. The wall structure comprises at least one bottom module 2i provided with apertures 10 for housing burners (not shown), bounding modules 2ii, 2iii, 2iv, 2v for bounding a melting tank 11 in cooperation with the bottom module 2i, at least one top module 2xii provided with a discharge opening 14 for discharging the gases produced in the melting tank 11 , and bounding modules 2vi, 2vii, 2viii, 2ix, 2x, 2xi for bounding an upward conveying labyrinth channel 17 for conveying said gases upwards from the port of the melting tank 11 to the discharge opening 14.

Although in the illustrated case the burners are installed from the bottom of the melting tank, in other solutions the burners can be installed on one side of the melting tank or from the top of the melting tank.

The bounding modules for bounding the labyrinth channel 17 comprise at least one module 2vi tilting upwards overlapping the port of the melting tank 11.

The tilted module 2vi protrudes upward inside the wall structure and with its side 24 adjacent to the melting tank 11 shields the discharge opening 14 from splashes of material coming from the melting tank 11 while with its side 25 opposite the melting tank 11 it bounds an accumulating zone 18 for accumulating material conveyed by the gases.

The accumulating zone 18 can be accessed through a suitable door 19 for emptying the material.

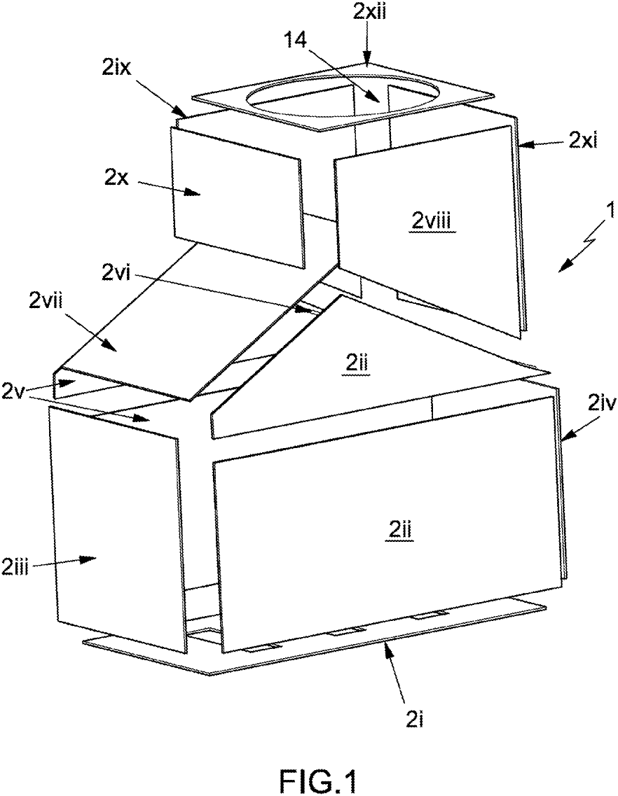

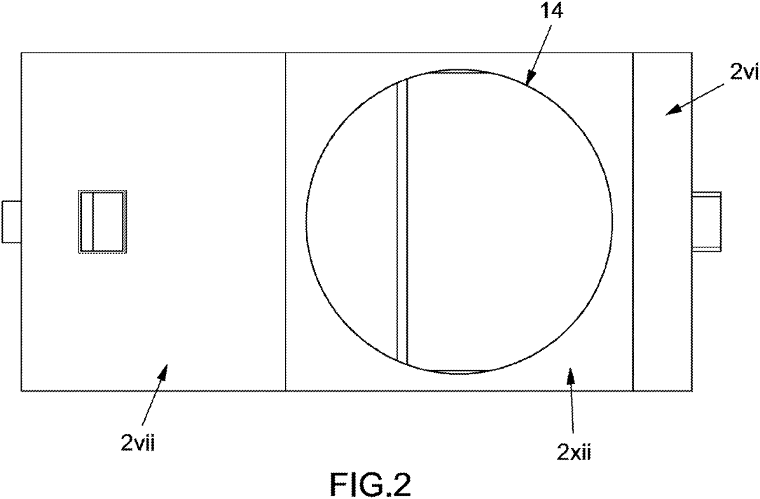

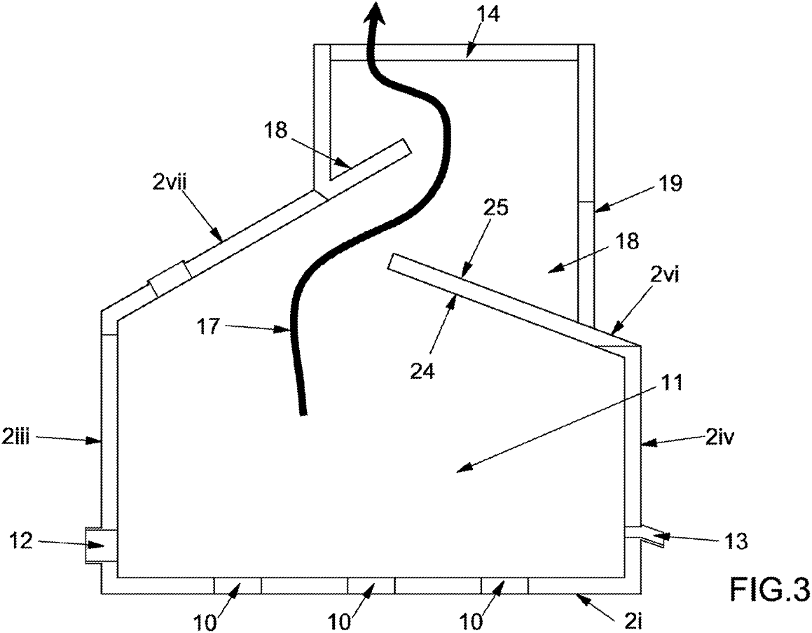

Reference is now made to the embodiment illustrated in FIGS. 1 - 3.

In this case, the bounding modules for bounding the labyrinth channel 17 comprise at least a second module 2vii tilting upwards that protrudes inside the wall structure and overlaps the port of the melting tank 11 converging toward the first tilted module 2vi.

More precisely, the first tilted module 2vi partially overlaps the port of the melting tank 11, the second tilted module 2vii partially overlaps the port of the melting tank 11 and extends until it also overlaps the first tilted module 2vi.

The labyrinth channel 17 thus has at least one passage section completely shielded from the port of the melting tank 11.

The wall structure of the furnace 1 comprises a rectangular bottom module 2i, a first array of four vertical modules 2ii, 2iii, 2iv, 2v that are orthogonal to each other for bounding the melting tank 11 , a second array of two vertical modules 2ii, 2v that are parallel to each other and coplanar with two modules 2ii, 2v of the first array with which they cooperate in order to bound the melting tank 11, the two modules 2vi, 2vii tilted upward bounding the labyrinth channel 17 with a third array of four vertical modules 2viii, 2ix, 2x, 2xi that are orthogonal to each other, and a top module 2xii.

In this case the four vertical modules 2ii, 2iii, 2iv, 2v of the first array are rectangular, the two vertical modules 2ii, 2v of the second array are triangular, the two tilted modules 2vi, 2vii are rectangular, two parallel vertical modules 2x, 2xi of the third array are rectangular but with different height and the other two parallel vertical modules 2viii, 2ix of the third array are trapezoidal, and the top module 2xii is rectangular.

Two sets of coplanar modules are each formed by a rectangular module of the first array, a triangular module of the second array and a trapezoidal module of the third array.

The modules are jointed together all on the perimeter except for the two tilted modules 2vi, 2vii which are jointed along an intermediate section thereof at one side of an overlying module 2xi, 2x.

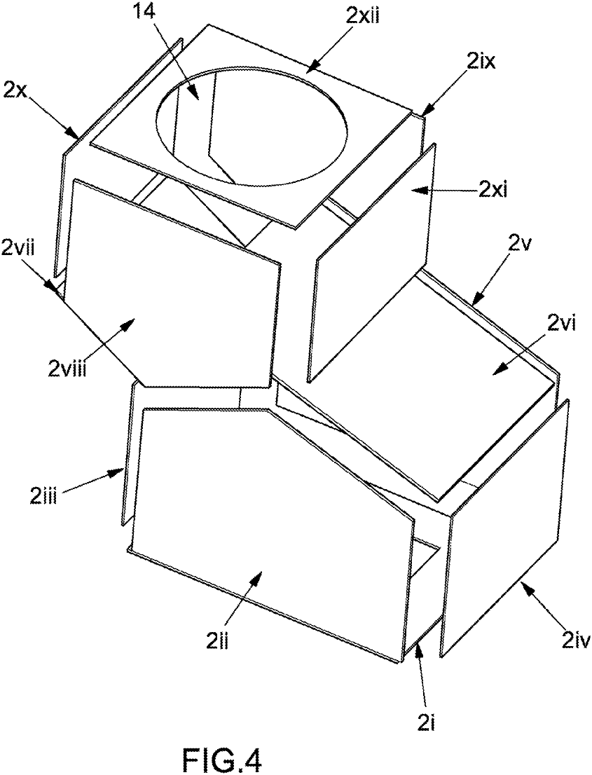

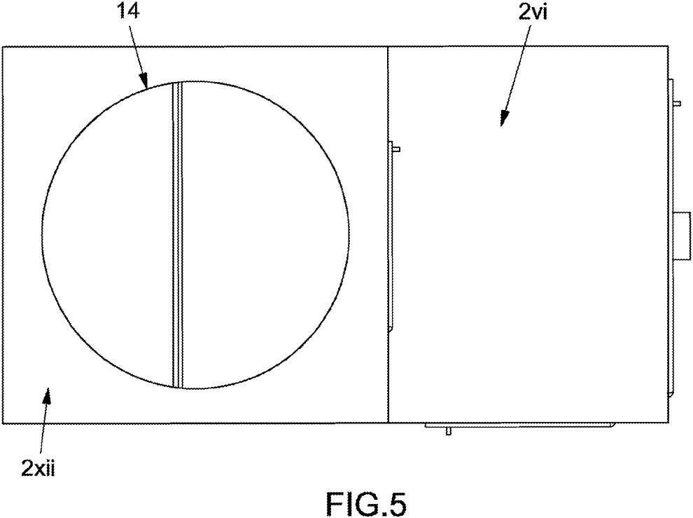

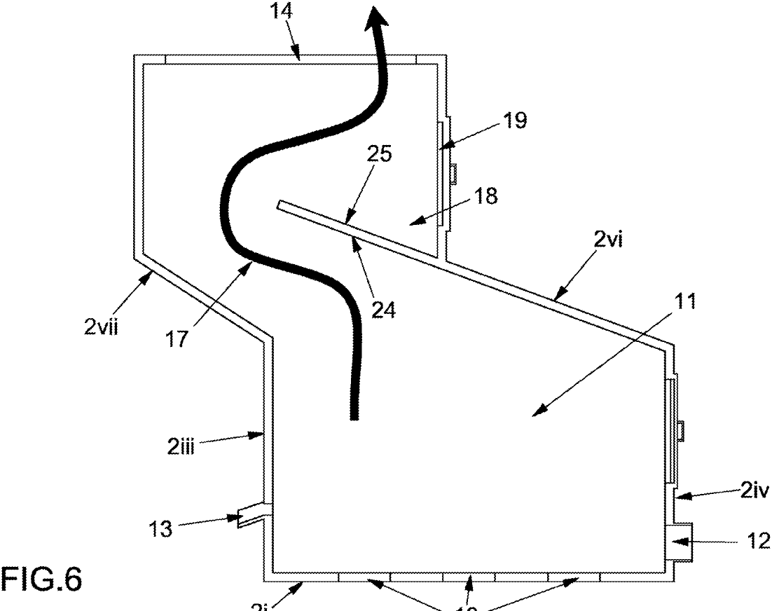

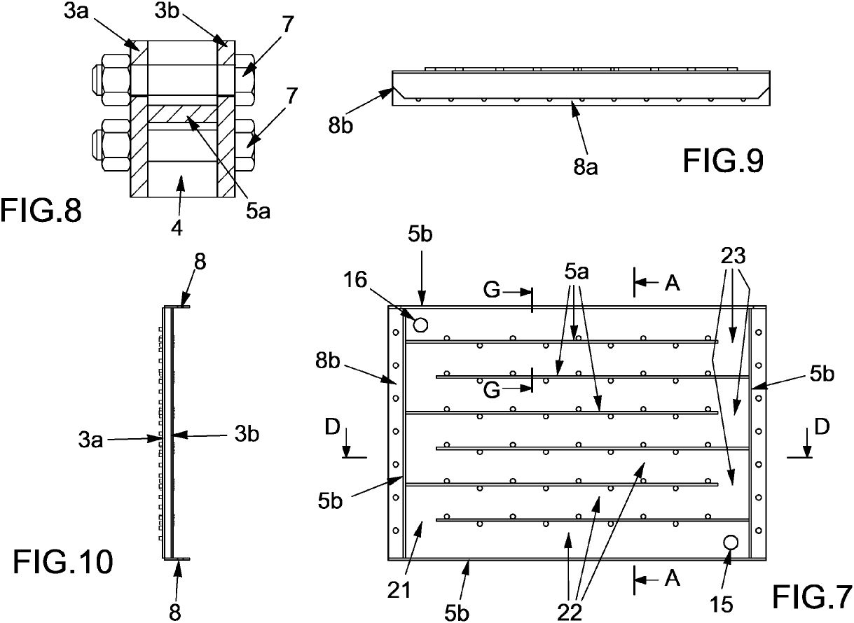

Reference is now made to the embodiment illustrated in FIGS. 4 - 6.

In this case, the bounding modules for bounding the labyrinth channel 17 comprise at least a second module 2vii tilted upwards that is staggered from the port of the melting tank 11.

The first tilted module 2vi completely overlaps the port of the melting tank 11 and extends toward the second tilted module 2vii.

The labyrinth channel 17 thus has at least one passage section completely shielded from the port of the melting tank 11.

The wall structure of the furnace 1 comprises a rectangular bottom module 2i, a first array of four vertical bounding modules 2ii, 2iii, 2iv, 2v that are orthogonal to each other for bounding the melting tank 11, the two bounding modules 2vi, 2vii tilted upward for bounding the labyrinth channel 17 with a second array of four vertical modules 2viii, 2ix, 2x, 2xi that are orthogonal to each other, and a top module 2xii.

In this case two parallel vertical modules 2iii, 2iv of the first array are rectangular and the other two parallel vertical modules 2ii, 2v of the first array are pentagonal, the two tilted modules 2vi, 2vii are rectangular, two parallel vertical modules 2x,

2xi of the second array are rectangular and the other two parallel vertical modules.

2viii, 2ix of the second array are pentagonal, and the top module 2xii is rectangular.

The pentagonal modules of the first and second array in pairs are coplanar and are joined along one side thereof.

The first tilted module 2vi which completely overlaps the melting tank 11 is joined along three of its four sides to homologous sides of two pentagonal modules 2ii, 2v and of a rectangular module 2iv of the first array.

The second tilted module 2vii is joined along one side thereof to a homologous side of a rectangular module 2iii of the first array and along the other three sides thereof to homologous sides of two pentagonal modules 2ii, 2v and of a rectangular module 2iii of the second array.

The modules are jointed together all on the perimeter except for the first tilted module 2vi which is jointed along an intermediate section thereof to one side of an overlying module 2xi.

A furnace for melting vitrifiable material according to an embodiment of the present disclosure does not strictly require water cooled modules.

Whether or not water cooled modules are provided, according to an embodiment of the present disclosure the bottom module 2i is rectangular or square shaped, has dimension of each perimeter side in a range between 2 m and 4 m, and preferably between 2.5 m and 3 m, has parallel rows of longitudinal apertures 10 for housing burners, those apertures 10 are parallel to two opposite perimeter sides of the bottom module 2i and have a pitch in a range between 0.3 m and 0.6 m, and preferably in a range between 0.35 m and 0.5 m, and a distance from the perimeter sides of the bottom module 2i in a range between 0.1 m and 0.7 m.

The position of the burners on the bottom of the furnace has a very important effect on the speed and melting process quality.

Incorrectly positioned burners can sometimes lead to significant deterioration in the melting process, and in some cases, block it completely.

The batch inlet 12 is organized from one side of the melting thank 11, for example from the side of module 2iv.

Moreover, raw materials can be supplied from the top of the melting tank 11, for example on module 2vi.

The melting outlet 13 is preferably located on the opposite side on module 2iii. However, if necessary, the melting outlet can be located on the left and right sides on modules 2ii and 2v.

Moreover, the melting outlet can be arranged on the bottom module of the furnace 2i.

The batch can be fed below the melting level or from above.

The melting tank 11 can have several doors for access to the inside, not shown for clarity’s sake in the figures, for monitoring the state of the inside of the furnace and for cleaning solidified particles.

It is very important to properly organize the evacuation of the fumes from the furnace.

Due to the intense bubbling of the melting inside the melting tank 11, droplets or large blocks of the melting can be taken up together with hot gases. When entering in the colder part of the labyrinth channel 17 these drops or blocks quickly cool down.

If the profile of the outlet labyrinth channel 17 was wrong, during furnace operation the cooled down drops or blocks might completely obstruct the outlet labyrinth channel 17.

Thus, a pressure pulsating field of hot gases could be created in the furnace above the melting tank 11.

These pressure pulsations above the melting tank 11 could create very large pulsations of the melted jet at the furnace outlet.

Consequently, the pulsation of the melted output of furnace could lead to a large degradation of the product quality at the exit from the fiberizing unit.

Furthermore, due to a wrong profile of the outlet labyrinth channel 17, large lumps of melting could be shot far into the flow.

The labyrinth channel 17 usually has a weaker thermal protection than the furnace itself: thus, there is a great risk of complete closure or wear of the flow material.

Advantageously the roof of the furnace is formed by two inclined modules 2vi and 2vii.

Both modules 2vi and 2vii are tilted and extend to an upward direction from the bounding modules 2ii, 2iii, 2iv, 2v for bounding the melting tank 11; the tilted modules can be contained inside the vertical perimeter generatrices of the base module or at least one can extend outside them.

Both modules 2vi and 2vii form a tapering rectangular labyrinth channel 17.

The angle of the module 2vi with the horizontal surface can be in the range from 5 degree to 20 degree.

The angle of the module 2vii with a horizontal surface can be in the range from 20 degree to 60 degree.

Typically, in a furnace according to the current disclosure the minimum section area of the labyrinth channel 17 is in the range from 0.5 m² to 2.5 m² provided for a flow velocity of the melting gases from 10 m/s to 20 m/s.

The overall outlet section 14 can be rectangular or square, and its total flow area should be from 2 to 3 times the minimum flow area.

The furnace for melting vitrifiable material thus conceived is susceptible of numerous modifications and variations, all of which are within the scope of the inventive concept; all the details may furthermore be replaced with technically equivalent elements.

In practice, the materials used, as well as the dimensions, may be any according to requirements and the state of the art.

1. A furnacefor melting vitrifiable material, wherein the furnace has a composable wall structure, formed by modules, each module comprising a first and a second flat metal panel separated by a gap for circulation of cooling water, wherein said wall structure comprises at least one bottom module, bounding modules for bounding a melting tankin cooperation with said bottom module, at least one top module provided with a discharge openingfor discharging gases produced in the melting tank, and bounding modules for bounding an upward conveying labyrinth channelfor conveying said gases upwards from a port of said melting tankto said discharge opening, wherein said bounding modules for bounding said labyrinth channel comprise at least one module tilting upwards overlapping the port of the melting tank, and wherein said tilted module protrudes upward inside said wall structure.

2. The furnaceaccording to claim 1, wherein said gapcomprisesbaffles for channelling the cooling water.

3. The furnaceaccording to claim 2, wherein said baffles are formed by flat metal strips fixed orthogonally to said first and second flat metal panels.

4. The furnaceaccording to claim 2, wherein said baffles comprise inner bafflesof the module and perimeter bafflesof the module, wherein the perimeter baffles close said gap on a perimeter of the gap, said inner bafflesbeing ordered in an array of parallel baffles separated by a passage space from said perimeter bafflesso as to define a water channel that extends as a coil.

5. The furnace according to claim 4, wherein said water channel has horizontal rectilinear portions connected by portions curved at 180°.

6. The furnaceaccording to claim 2, wherein the first and second panels of each module are connected by bolts that traverse said gap.

7. The furnaceaccording to claim 2, wherein said modules have perimeter coupling flanges.

8. The furnaceaccording to claim 7, wherein said modules have reciprocal fixing bolts at said perimeter flanges.

9. The furnaceaccording to claim 1,wherein a side of said tilted module opposite said melting tank bounds an accumulating zonefor accumulating material conveyed by said gases.

10. The furnaceaccording to claim 1, wherein said labyrinth channel has passage sections of a different area to accelerate and slow down an ascending flow of the gases.

11. The furnaceaccording to claim 9, wherein solidified material that is deposited in said accumulating zoneforms a sliding surface of another material sliding to the melting tank.

12. The furnaceaccording to claim 1, wherein said tilted module is arranged as a barrier that, by intercepting ascending flow of the gases, is configured to promoter separating, from the ascending flow, particles of solidified material that slide along said tilted module to return to the melting tank.

13. A furnace for melting vitrifiable material, wherein the furnace comprises:
a composable wall structure comprising at least one bottom module, bounding modules for bounding a melting tank in cooperation with said bottom module, at least one top module provided with a discharge openingfor discharging gases produced in the melting tank, and bounding modules for bounding an upward conveying labyrinth channelfor conveying said gases upwards from a port of said melting tank to said discharge opening,
wherein said bounding modules for bounding said labyrinth channel comprise at least one module tilting upwards overlapping the port of the melting tank,
wherein said tilted module protrudes upward inside said wall structure,
wherein said bottom moduleis rectangular or square shaped having a dimension of each perimeter side in a range between 2 m and 4 m, and having rows of apertures for housing burners, the rows being parallel to two opposite perimeter sides of said bottom module, said apertures having a pitch in range between 0.3 m and 0.6 m and a distance from said perimeter sides in a range between 0.1 m and 0.7 m.

14. The furnaceaccording to claim 13, wherein said module tilting upwards is inclined upwards by an angle with a horizontal surfacebetween 5 degrees and 20 degrees.

15. The furnaceaccording to claim 13 wherein a smallest section area of said labyrinth channel is in the range from 0.5 m² to 2.5 m² provided for a flow velocity of the melting gases from 10 m/s to 20 m/s.

16. A furnace for melting vitrifiable material, the furnace comprising:
a melting tank and a gas exhaust channel, wherein the melting tank comprises a bottom having substantially rectangular shape, side walls and a top arranged opposite the bottom, wherein the gas exhaust channel comprises a discharge opening in fluid communication with the melting tank,
wherein the furnace comprises a wall structure comprising multiple wall modules bounding the melting tank and the gas exhaust channel, wherein a first one of the multiple wall modules bounds the top of the melting tank and extends from a first side wall of the melting tank inclined relative to horizontal at an angle between 5 degrees and 20 degrees upwards in a direction departing from the first side wall, wherein a second one of the multiple wall modules extends from a second side wall of the melting tank opposite the first side wall and is inclined relative to the horizontal, wherein the first one of the multiple wall modules protrudes inside the gas exhaust channel to form a first baffle which at least partially overlaps the melting tank, wherein a gas exhaust path is located between the first one and the second one of the multiple wall modules.

17. The furnace of claim 16, wherein the second one of the multiple wall modules bounds the top of the melting tank and is inclined relative to the horizontal at an angle between 5 degrees and 20 degrees upwards in a direction departing from the second side wall and approaching the first one of the multiple wall modules, wherein the second one of the multiple wall modules protrudes inside the gas exhaust channel to form a second baffle which at least partially overlaps the melting tank, such that the first baffle and the second baffle completely overlap the melting tank, and wherein a free edge of the second baffle is elevated with respect to a free edge of the first baffle to make the gas exhaust path tortuous.

18. The furnace of claim 17, wherein the second baffle at least partially overlaps the first baffle.

19. The furnace of claim 16, wherein the second one of the multiple wall modules extends from the second side wall in an outward direction and is inclined relative to the horizontal at an angle between 5 degrees and 20 degrees upwards in a direction departing from the second side wall, wherein the first baffle protrudes inside the gas exhaust channel beyond a position corresponding with the second side wall, wherein the first baffle and the second one of the multiple wall modules bound a portion of the gas exhaust path.

20. The furnace of claim 16, wherein the gas exhaust channel comprises vertical wall sections formed by a plurality of the multiple wall modules, wherein the vertical wall sections extend from the first one of the multiple wall modules and from the second one of the multiple wall modules.
